(19) United States
(12) Patent Application Publication
(10) Pub. No.: US 2025/0350108 A1
(43) Pub. Date: Nov. 13, 2025

(54) ELECTRONIC FUSE WITH DYNAMIC SHUTOFF CURRENT

(71) Applicant: Rivian IP Holdings, LLC, Irvine, CA (US)

(72) Inventors: Thomas ROCROI, Richmond, CA (US); Glenn Morris FEINBERG, Carlsbad, CA (US)

(21) Appl. No.: 19/179,639

(22) Filed: Apr. 15, 2025

Related U.S. Application Data
(60) Provisional application No. 63/643,406, filed on May 6, 2024.

(51) Int. Cl. H02H 3/08; H02H 1/00

(52) U.S. Cl. CPC H02H 3/08; H02H 1/0007

(57) ABSTRACT

An electronic fuse is configured to sense a measured current through the electronic fuse and calculate a summation based on an amount of the measured current over time. The electronic fuse evaluates the summation with respect to an area defined according to a current squared with respect to time (I²t) plot for a wire specification. The electronic fuse shuts off current through the electronic fuse if the summation exceeds the area. The electronic fuse may control the flow of current to a device through a wire according to the wire specification. The electronic fuse may be part of a vehicle, such as a battery electric vehicle.

### RELATED APPLICATION

This application claims the benefit of U.S. Application Ser. No. 63/643,406 filed May 6, 2024 and entitled ELECTRONIC FUSE WITH DYNAMIC SHUTOFF CURRENT.

### INTRODUCTION

The present disclosure relates to an electronic fuse (eFuse).

### SUMMARY

The present disclosure describes techniques for implementing an electronic fuse. In one aspect, an electronic fuse is configured to sense a measured current through the electronic fuse and calculate a summation based on an amount of the measured current over time. In various embodiments, the electronic fuse evaluates the summation with respect to an area defined according to a current squared with respect to time (12t) plot for a wire specification. The electronic fuse shuts off current through the electronic fuse if the summation exceeds the area.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic diagram showing the transfer of current to a device through an electronic fuse in accordance with certain embodiments.

FIG. 4 is a cross-sectional diagram of a wire.

FIG. 5 is a process flow diagram of a method for controlling an electronic fuse in accordance with certain embodiments.

FIG. 6 is an I²t plot for a wire along with an area used for dynamically determining when to shut off the electronic fuse in accordance with certain embodiments.

FIG. 7 is a plot of current with respect to time for evaluation in accordance with certain embodiments.

FIG. 8 is a plot of summations of excess current squared over time for use in determining when to shut off the electronic fuse in accordance with certain embodiments.

### DETAILED DESCRIPTION

Vehicles rely on fuses to avoid dangerous levels of current that may result from damage to a wire or failure of a component that draws current through the fuse. The amount of current that may safely be transmitted through a wire is time dependent. A component may temporarily draw large amounts of current that is still safely transmitted through a wire even though the wire could not sustain that amount of current indefinitely.

The wires of a vehicle may be made smaller, and correspondingly lighter, less expensive, and more flexible, by a using an electronic fuse that accounts for the duration of current spikes rather than simply the magnitude of current spikes. In various embodiments, the electronic fuse disclosed herein calculates a summation of current in excess of a rated current for a wire and shuts off current when the summation exceeds an area defined according to an I²t relationship (e.g., an I²t function or chart) for the wire.

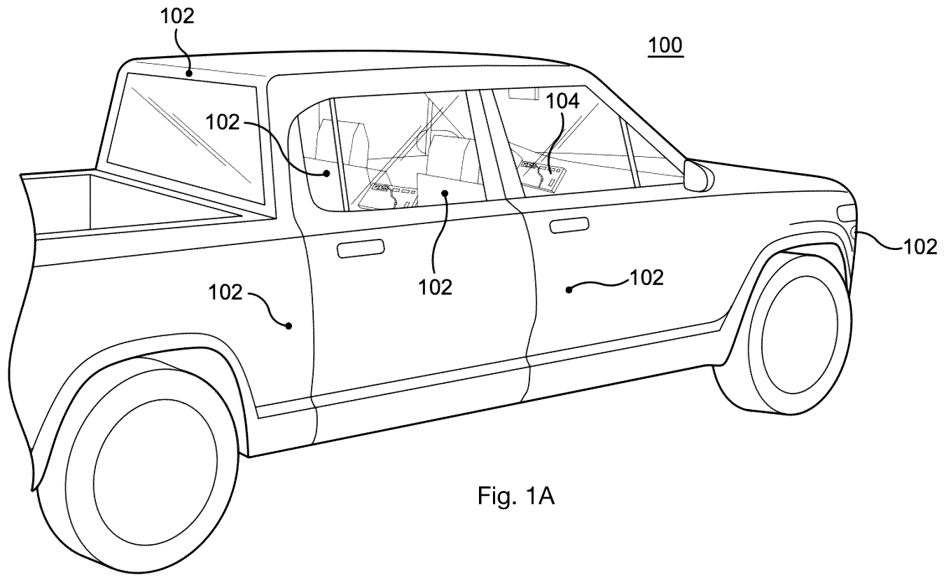

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIGS. 1B and 1n the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

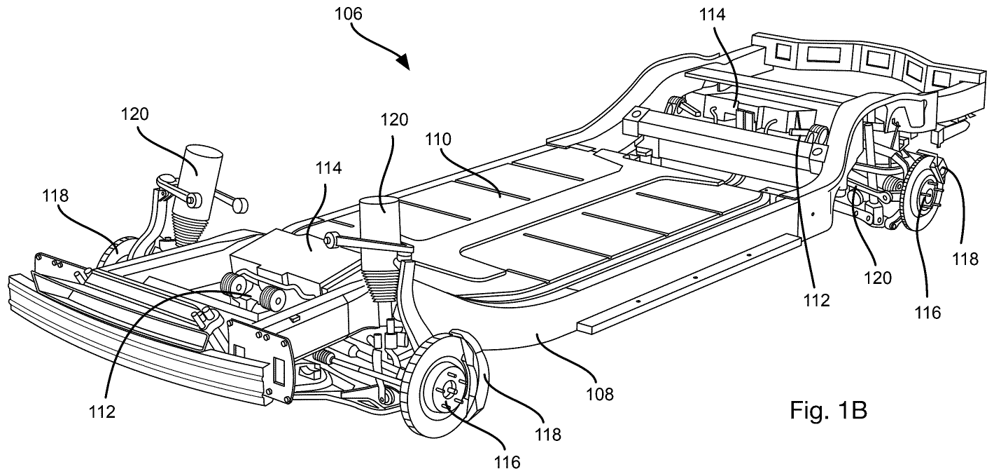

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power electronics 114, temperature of each drive unit 112 and/or each motor of each drive unit 112, temperature of coolant fluid entering or leaving a coolant system, temperature of oil within a drive unit 112, or the temperature of any other component of the vehicle 100.

The components of the vehicle 100 may include a friction braking system 210. The friction braking system 210 may include any components of a hydraulic braking system, such as a rotor, brake pads, calipers, caliper pistons, a master cylinder coupled to the brake pedal and coupled to the caliper pistons by brake lines. The friction braking system 210 may further include a pump and/or valves for automatically applying hydraulic pressure to the caliper pistons. The friction braking system 210 may be implemented as a drum braking system or any friction braking system known in the art.

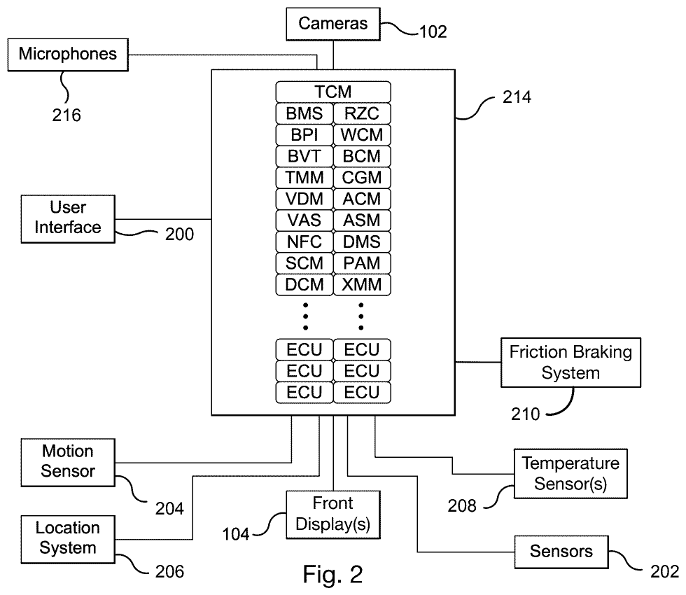

A control system 214 executes instructions to perform at least some of the actions or functions of the vehicle 100, including the functions described in relation to FIGS. 3 to 6. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions. Each ECU may be a computer system and each ECU may include functionality described below.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for performing, for example, the operations and functions described below.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

The ECUs may include one or more ECUs that are configured to control the friction braking system 210. For example, the ECUs may include a traction control module, a stability control system, automated emergency braking (AEB) module, anti-lock braking system (ABS), adaptive cruise control module (ACC), and/or an automated driving assistance system (ADAS). The traction control module controls braking and acceleration to control wheel slip according to any approach known in the art. The traction control module may also control the torque applied at each wheel, i.e., torque vectoring. The stability control system controls braking and acceleration in order to avoid rollovers of the vehicle 100 according to any approach known in the art. The AEB module stops the vehicle 100 in a controlled manner response to predicted collisions according to any approach known in the art. The ABS modulates braking to maintain traction. The ACC maintains a speed of the vehicle while also maintaining a prescribed following distance with respect to other vehicles. The ADAS controls steering, acceleration, and braking of the vehicle 100 to arrive at a destination according to any self-driving approach known in the art.

Referring to FIG. 3, power may be supplied to a device 300 of the vehicle 100 through an electronic fuse 302 (“eFuse”). The electronic fuse 302 is an electronic switch having the capability to measure current through the electronic fuse 302 and evaluate the measured current according to logic in order to determine whether to open the switch to prevent harm to the device 300 from current supplied by the electronic fuse 302.

The device 300 may be a light, motor, heating element, ECU, or any other component of the vehicle 100. The device 300 may be a motor of a drive unit 112, a pump for adjusting a suspension 120, or the like. The electronic fuse 302 may also be used in non-vehicular applications device such that the device 300 may be any device drawing electrical current.

The electronic fuse 302 may be incorporated into a zonal controller 304 controlling the supply of power to components within a particular region of the vehicle 100 or components of one or more types (e.g., having a common supply voltages and/or current requirements). The zonal controller 304 may include an on-board power supply 306. The on-board power supply 306 may receive current from a power supply 308, such as the battery 110, and perform a voltage reduction. For example, the battery 110 may output 400 Volts, 800 Volts, or higher voltage whereas the output of the on-board power supply 306 is much less, e.g., 12, 24, or 48 Volts.

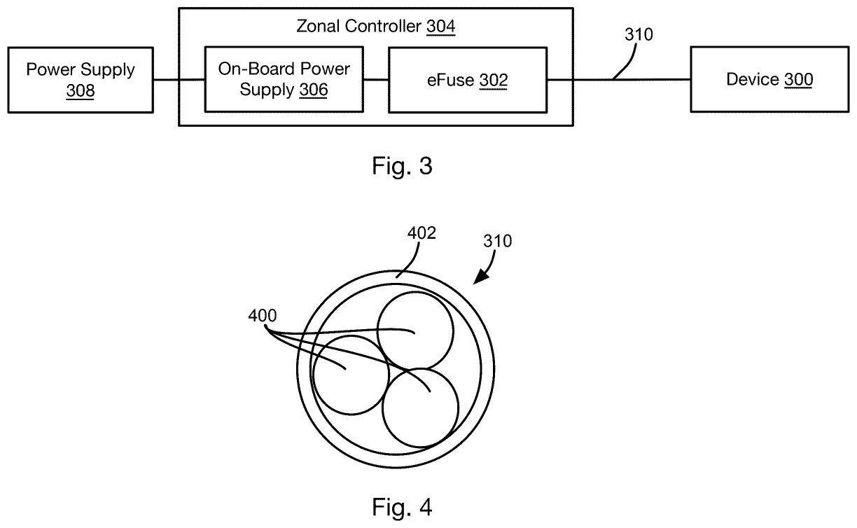

The electronic fuse 302 is coupled to the device 300 by a wire 310. The wire 310 may be a wire as shown in FIG. 4, which includes one or more bundles 400 of metal strands surrounded by an insulator 402. The bundles 400 may include copper wires that may be twisted or braded together. The insulator 402 is typically a polymer with dielectric properties.

As current is conducted through the wire 310, resistance to the flow of current through the metal of the one or more bundles 400 will cause heat to build up. Under acceptable operating conditions, the heat will dissipate through the insulator 402. As the amount of current increases, the heat will be generated faster than can be dissipated to ambient material (i.e., adiabatic heating). The temperature of the one or bundles 400 may reach a fume temperature of the insulator 402, at which point the insulator 402 will begin to disintegrate.

The current at which a wire 310 reaches the fume temperature is a function of ambient temperature, current (I) squared, and duration (t) of the current. Accordingly, each wire 310 specification has a corresponding squared current with respect to time (It) relationship for a standard ambient temperature, e.g., 25 degrees Celsius or higher. The I²t relationship shows the amount of time the wire 310 may conduct a given amount of current before reaching the fume temperature. The rated current for a wire 310 is the amount of current the wire 310 can transmit indefinitely without failing at the standard ambient temperature.

The device 300 receiving current over the wire 310 from the electronic fuse 302 may have an irregular current draw. For example, most components will draw a large amount of current initially but then settle at a much lower current draw. For example, electric motors exhibit such behavior. Using the approach described herein, electronic fuse 302 may account for the duration of current above the rated current of the wire 310 to determine whether to shut off current to the device 300. The wire 310 may therefore be made smaller, which reduces the cost and weight of the wire 310 and increases flexibility of a wiring harness including the wire 310.

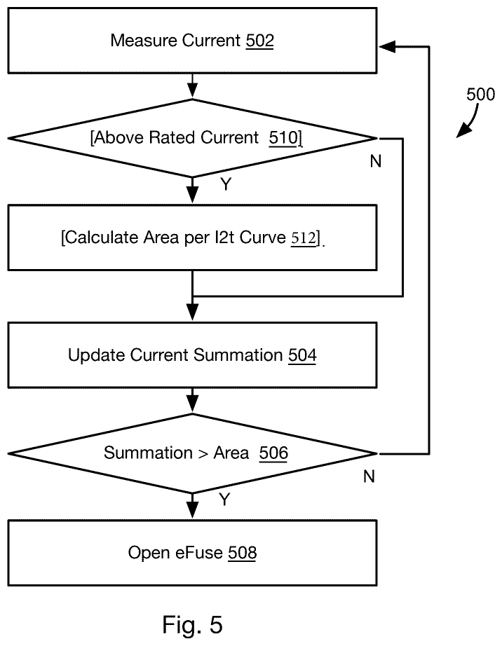

FIG. 5 illustrates a method 500 that may be executed by the electronic fuse 302. The method 500 may include measuring, at step 502, current through the electronic fuse 302. The measurements may be performed periodically, such as at a sampling period Δt. The method 500 may include updating, at step 504, a summation. The summation may approximate an integral of a difference between the square of the measured current for the current sample

$$( {I}_{M}^{2} )$$

and the square of the rated current

$$( {I}_{R}^{2} )$$

or the wire 310 over time. For example, the summation (S) may be calculated according to (1), where S is initialized to zero prior to the first iteration of step 504. As is apparent in (1), the summation may be constrained to be positive.

$$S = Max ( S + ( {I}_{M}^{2} - {I}_{R}^{2} ) Δ t , 0 ) \qquad ( 1 )$$

The method may include evaluating, at step 506, the summation S with respect to an area (A) determined based on the I²t relationship for the wire 310. If S>A, then the electronic fuse 302 may open at step 508 thereby shutting off supply of current to the device 300. Otherwise, a subsequent iteration of the method 500 may be performed beginning at step 502. If the electronic fuse 302 is opened, the method 500 may end until further action is performed. The electronic fuse 302 may remain open until closed by another entity, such as resetting of the electronic fuse 302 by a human operator or other software component, e.g., a reset of the control system 214. In some embodiments, whether the electronic fuse 302 may be reset by the control system 214 is a function of I_{M}, e.g., automatic resetting by the control system 214 may be permitted if opening of the electronic fuse 302 was not preceded by I_{M} above a threshold current. Otherwise, resetting by a human operator may be required. Resetting by the control system 214 may be permitted up to a predetermined number of times, after which human resetting is required.

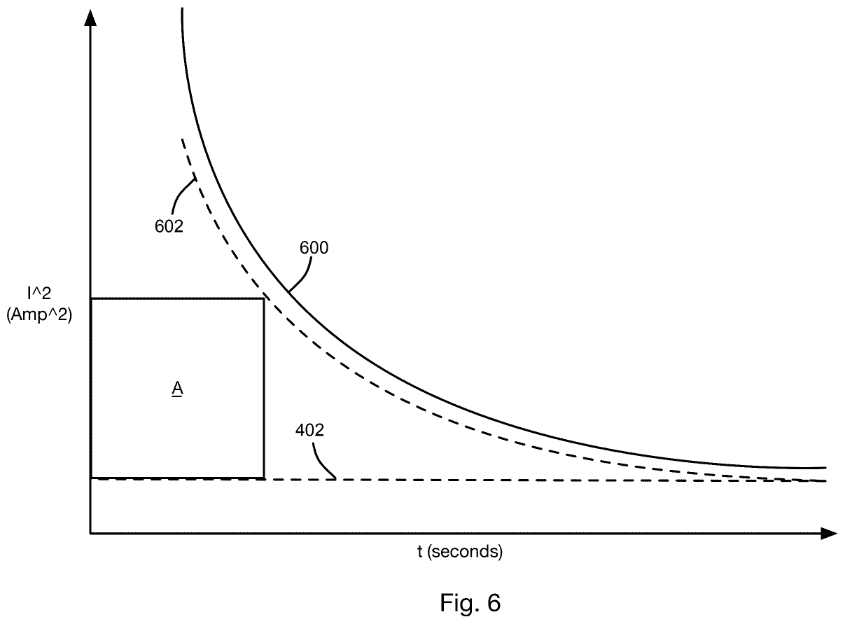

The area A may either be a fixed value or may be determined dynamically. For example, A may be determined by evaluating, at step 510, whether the measured current is above the rated current and, if so, calculating, at step 512, the area A based on the I²t relationship for the wire 310 (see FIG. 6 and corresponding discussion). The evaluation of step 506 for a measurement of step 502 may then be performed using the area A calculated at step 502 for that measurement. Where step 512 is not invoked, the area A may be a default area A or an area A calculated for a previous iteration of the method 500.

FIGS. 6, 7, and 8 illustrate the manner in which the area A is calculated and used. FIG. 6 illustrates a plot 600 of current squared (12) with respect to time (t) for the wire 310, such as might be provided by a manufacturer of the wire. The plot 600 may be an I²t plot according to a specification for the wire 310. The rated current I_{R} may also be according to the specification for the wire 310. The plot 600 may be derated, i.e., indicate limits for the duration of a given current that are artificially reduced to provide a safety margin. The plot 600 may be further derated to obtain plot 602, e.g., I² values reduced by X percent, where X is a value between 10 and 20, such as 15 percent.

The area A may be the area of a rectangle with a first corner at

$${I}^{2} = {I}_{R}^{2}$$

and t=0 and a second corner on the derated plot 602 for a selected value of I² above

$${I}_{R}^{2} .$$

derated plot 602 may be selected to either (a) provide the smallest area A of all possible points on the derated plot 602 or (b) correspond to the measured current I_{M} from step 502 (e.g.,

$${I}_{M}^{2} ) .$$

The default value for A may be the smallest area A. In some embodiments, step 506 may include either using the smaller of (a) value of A from an immediately preceding iteration of the method 500 and (b) the value of A for the measured current I_{M} from step 502 of the current iteration of the method 500.

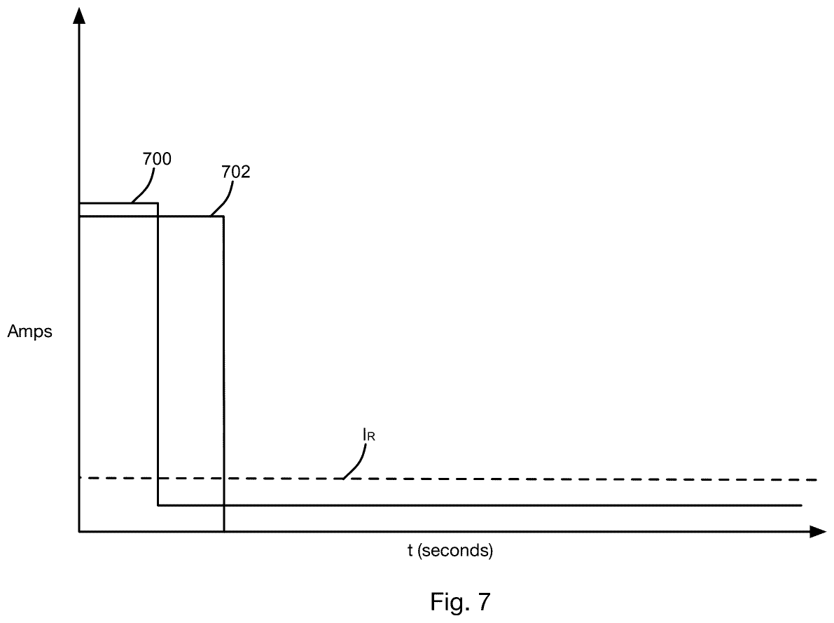

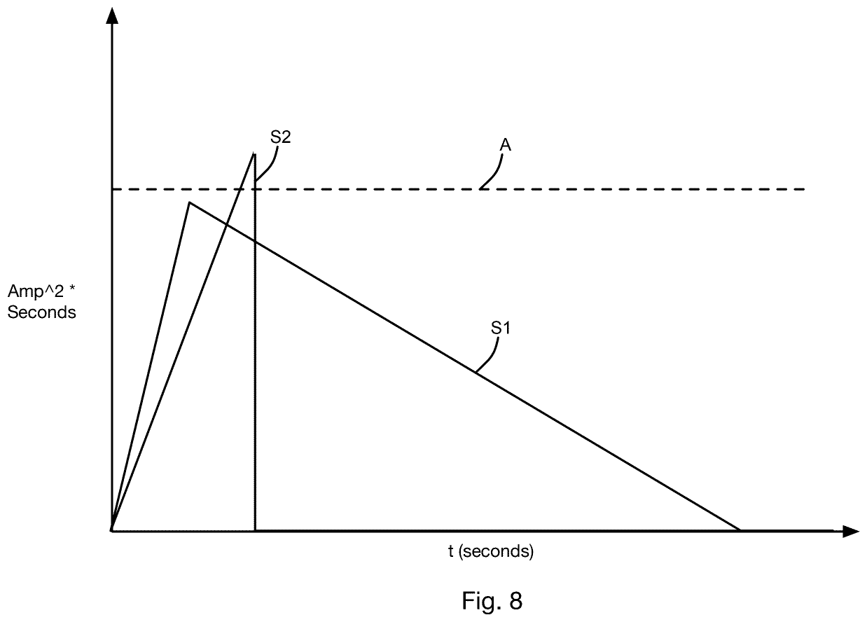

FIGS. 7 and 8 illustrate possible scenarios that may occur using the method 500. FIG. 7 shows plots 700, 702 of measured current over time showing pulses above I_{R} having the illustrated magnitude and duration followed by current falling below I_{R} in the case of plot 700.

FIG. 8 illustrates possible summations S1 and S2 calculated according to (1) for the plots 700, 702, respectively. As shown by summation S1, the summation rises to a peak value below A and then falls as the current falls below I_{R} and the term

$$( {I}_{M}^{2} - {I}_{R}^{2} )$$

Δt in (1) becomes negative. FIG. 8 further shows that summation S1 does not fall below zero as defined by (1). For example, in some embodiments, the electronic fuse is configured to calculate the summation such that the summation is never negative. In some embodiments, the area A is restored to a default value or set to 0 once the summation S1 falls to zero in cases where the area A is not fixed. The area A may then be set in subsequent iterations of the method 500 when current rises above I_{R}.

As shown in FIG. 8, summation S2 does rise above A, at which point the electronic fuse 302 will open and current will cease flowing through the electronic fuse 302. The use of the derated plot 602 to calculate A ensures that any overshoot of the area A due to the finite reaction time of the electronic fuse 302 will not cause failure.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. An apparatus comprising:
an electronic fuse configured to:
sense a measured current through the electronic fuse;
calculate a summation based on an amount of the measured current over time;
evaluate the summation with respect to an area defined according to a current squared with respect to time (It) relationship for a wire specification; and
shut off current through the electronic fuse if the summation exceeds the area.

2. The apparatus of claim 1, wherein the electronic fuse is configured to calculate the summation based on an amount of the measured current in excess of a rated current over time, the rated current being according to a wire specification.

3. The apparatus of claim 2, wherein the electronic fuse is configured to calculate the summation as a difference between a square of the measured current and a square of the rated current over time.

4. The apparatus of claim 3, wherein the electronic fuse is configured to calculate the summation such that the summation is never negative.

5. The apparatus of claim 2, wherein the electronic fuse is configured to calculate the summation by updating the summation(S) for each sample I_{M} of the measured current according to
$$S = Max ( S + ( {I}_{M}^{2} - {I}_{R}^{2} ) Δ t , 0 ) ,$$
where I_{R} is the rated current and Δt is a sample period at which the electronic fuse measures the current through the electronic fuse.

6. The apparatus of claim 2, further comprising a wire according to the wire specification connected to the electronic fuse.

7. The apparatus of claim 6, further comprising a device connected to the wire, the device configured to draw current in excess of the rated current during normal operation of the device.

8. The apparatus of claim 7, wherein the device is a component of a vehicle.

9. The apparatus of claim 1, wherein the area is a size of a rectangular region having a first corner at time=0 and the rated current and a second corner at a point on a derated version of the I²t relationship.

10. The apparatus of claim 9, wherein the derated version of the I²t relationship is reduced by at least 10 percent relative to the I²t relationship.

11. A method comprising:
sensing, by an electronic fuse, a measured current through the electronic fuse;
calculating, by the electronic fuse, a summation based on an amount of the measured current over time;
evaluating, by the electronic fuse, the summation with respect to an area defined according to a current squared with respect to time (I²t) relationship for a wire specification;
determine, by the electronic fuse, that the summation is greater than the area; and
in response to determining that the summation is greater than the area, shutting off, by the electronic fuse, current through the electronic fuse.

12. The method of claim 11, further comprising calculating, by the electronic fuse, the summation based on an amount of the measured current in excess of a rated current over time, the rated current being according to a wire specification.

13. The method of claim 12, further comprising calculating, by the electronic fuse, the summation as a difference between a square of the measured current and a square of the rated current over time.

14. The method of claim 13, further comprising calculating, by the electronic fuse, the summation such that the summation is never negative.

15. The method of claim 12, further comprising calculating, by the electronic fuse, the summation by updating the summation(S) for each sample I_{M} of the measured current according to
$$S = Max ( S + ( {I}_{M}^{2} - {I}_{R}^{2} ) Δ t , 0 ) ,$$
where I_{R} is the rated current and Δt is a sample period at which the electronic fuse measures the current through the electronic fuse.

16. The method of claim 12, wherein a wire according to the wire specification is connected to the electronic fuse.

17. The method of claim 16, wherein a device is connected to the wire, the device drawing current in excess of the rated current during normal operation of the device.

18. The method of claim 7, wherein the device is a component of a vehicle.

19. The method of claim 11, wherein the area is a size of a rectangular region having a first corner at time=0 and the rated current and a second corner at a point on a derated version of the I²t relationship.

20. The method of claim 19, wherein the derated version of the I²t relationship is reduced by at least 10 percent relative to the I²t relationship.
